(19) United States
(12) Patent Application Publication
(10) Pub. No.: US 2013/0235161 A1
(43) Pub. Date: Sep. 12, 2013

(54) System and method for pulsed illumination interferometry

(71) Applicant: John H. Bearden, Woodstock, GA (US)

(72) Inventor: John H. Bearden, Woodstock, GA (US)

(21) Appl. No.: 13/723,192

(22) Filed: Dec. 20, 2012

Related U.S. Application Data
(60) Provisional application No. 61/577,819, filed on Dec. 20, 2011.

(51) Int. Cl. H04N 13/02

(52) U.S. Cl. CPC H04N 13/0275
USPC 348/46

(57) ABSTRACT

A scanning interferometer for obtaining surface profile data for an object to be scanned in which a carriage-driven focal mechanism moves through a range of predetermined scan positions at which interference fringe images are to be captured while using a high resolution, linear position measurement device attached to the motor-driven carriage in order to identify its precise vertical scan position, and both light pulses are emitted and an image capture device is triggered into simultaneous operation only upon the position measurement device signaling that the focal mechanism is arrived at one of the predetermined scan positions.

This non-provisional application claims the benefit of provisional application No. 61/577,819 filed Dec. 20, 2011.

### BACKGROUND OF THE INVENTION

Scanning interferometry involves splitting a light beam emitted from a light source (e.g., a laser) into two identical beams and directing them along divergent paths through a focal mechanism and toward an object surface being measured and a reference mirror, respectively. The beams then reflect off of the reference and object surfaces and are recombined as interfering beams that are directed toward an image capture device (e.g., a digital camera). The image capture device captures a multitude of image frames of interference fringes—all done while moving the focal mechanism (and the relatively fixed reference mirror) along a path normal to the plane of the object surface, or scanning, at a precise, constant speed which causes the optical path differences between the object surface and the reference mirror to vary and, therefore, the intensity of interference fringes to vary from frame-to-frame. Those interference fringes are then converted into three-dimensional data representing the topography of the object surface.

The process of converting registered fringe intensity patterns into 3-D topographic data requires knowledge of the relative scan positions of each successive captured frame. Traditionally, determining the relative positions of image frames has been accomplished by virtue of moving the focal mechanism at a predetermined speed and capturing the images at predetermined time intervals. However, because environmental conditions such as vibration and nonlinearities affect that movement, scan step sizes can deviate from and produce errors in the converted data.

### SUMMARY OF THE INVENTION

The present method departs from known interferometry methods for determining relative positions, or “optical path differences,” in that it comprises (1) predetermining a set of scan positions at which interference fringe images are to be captured; (2) moving a carriage-driven focal mechanism through that range of positions while using a high resolution, linear position measurement device attached to the motor-driven carriage in order to identify its precise vertical scan position; (3) triggering emission of pulsed light (e.g., LED) only upon the position measurement device signaling that the focal mechanism is arrived at one of the predetermined scan positions; and (4) simultaneously triggering operation of the image capture device (i.e., momentarily opening its shutter).

This method is important for a couple of reasons. First, because a high resolution measurement device (e.g., 10 nm encoder) is used to signal operation of the image capture device, interference fringe images are collected only while the optical path difference, between the reference and measuring beams, is at a predetermined measurement. Furthermore, if any computation delay occurs within the image capture process, the position of all frames can be known. And rather than having to apply an algorithmic method to mitigate inconsistencies in scan steps made by the focal mechanism throughout a continuous, unidirectional range of scan movement, the focal mechanism could conceivably be re-run through a scanning range in a repeat effort to capture images at predetermined intervals previously missed. Then, secondly, since and LED is pulsed synchronicity with the image capture device shutter being open for a very short time, the captured interference fringes are “frozen” and not blurred distortions due to movement of the focal lens occurring during the capture of a single image frame. This enables scanning at virtually any speed.

The evaluation of 3-D contours derived from the fringe intensity patterns obtained using the present method is more consistent and tolerant of internal as well as external environmental effects. A preferred embodiment of a system for practicing this method would utilize a programmable dividing circuit to set the shutter trigger signal spacing as a function of the encoder resolution. For example, if the utilized encoder has a resolution of 10 nm, the system could be programmed to trigger a camera to operate at an image spacing of 20 frames per micron. The dividing circuit would be programmed to divide the encoder signal by 5 before sending the signal to the camera. Since the encoder signal is typically quadrature in nature, filtering circuitry can be incorporated to insure that position reversals caused by vibrational or environmental perturbations can be taken into account. Motor speed multiplied by frame resolution is simply set at a level less than the inverse of the exposure timing. Additional quality assurance methodology can be incorporated that would monitor and correct for motion errors that send shutter trigger signals with timing outside of a predefined tolerance bracket.

Apparatus components: (1) interferometer (including camera and LED); (2) drive motor; (3) encoder that provides position feedback; (5) programmable, position sensitive circuit that triggers the camera and pulses the LED

### BRIEF DESCRIPTION OF THE DRAWINGS

FIG. 1 is a block diagram showing a system for obtaining surface profile data using pulsed illumination interferometry according to an embodiment of the present invention.

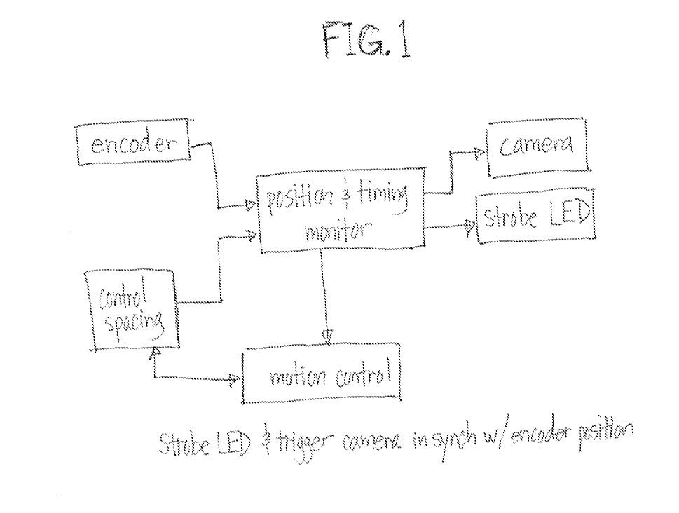

1. A system for obtaining surface profile data for an object, the system comprising:
an illuminator configured to emit pulses of light;
a light directing mechanism configured to split each light pulse into a reference beam and an object beam and direct them along a reference path and a object path, respectively, in which the reflection of the reference beam by a reference surface and the reflection of the object beam by the object surface are combined into an interference beam;
a drive mechanism configured to effect relative movement of the reference surface and object;
an image detector operatively coupled to the drive mechanism and configured to capture images of the interference beam;
a position measurement device for determining the position of the reference surface, wherein the position measurement device controls synchronous operation of the illuminator and image detector;
a computer configured to generate a surface profile map based upon the images captured by the image detector; and
wherein the illuminator and the image detector are signaled by the position measurement device to synchronously operate.

2. The surface profiling system of claim 1, wherein said light directing mechanism is an interferometer.

3. The surface profiling system of claim 1, wherein said position measurement device signals said illuminator and said image detector to operate only when the reference surface is arrived at predefined positions.

4. The surface profiling system of claim 1, wherein said illuminator is a light emitting diode (LED)

5. The surface profiling system of claim 1, wherein said position measurement device is a high resolution linear encoder.

6. The surface profiling system of claim 1, wherein said image detector is a digital camera.

7. The surface profiling system of claim 1, wherein said light directing mechanism is an interferometer.
